(19) United States
(12) Patent Application Publication
(10) Pub. No.: US 2008/0320531 A1
(43) Pub. Date: Dec. 25, 2008

(54) SYSTEMS AND METHODS FOR THIRD-PARTY AGGREGATED VIDEO RATINGS

(75) Inventors: Peter H.I. Kim, Pasadena, CA (US); Hyo Lee, Pasadena, CA (US)

Correspondence Address: BAKER & MCKENZIE LLP;PATENT DEPARTMENT, 2001 ROSS AVENUE, SUITE 2300, DALLAS, TX, 75201, US

(73) Assignee: INTERPOLS NETWORK INCORPORATED, Pasadena, CA (US)

(21) Appl. No.: 12/146,246

(22) Filed: Jun. 25, 2008

Related U.S. Application Data
(60) Provisional application No. 60/946,074, filed on Jun. 25, 2007.

(51) Int. Cl. H04N 7/173

(52) U.S. Cl. 725/87; 725/32

(57) ABSTRACT

A computer implemented method for providing a third-party video content rating unit to a client device, is disclosed. A web browser running on the client device requests video content from an affiliate video content server. The media player running on the client device receives a data stream of the video content from the affiliate video content server, renders the video content and sends a request for the third-party video content rating unit to a third-party ad content server once the video content has been completely rendered. The third-party ad content server receives the request for the third-party video content rating unit, sends the third-party video content rating unit to the client device and streams advertising content to the third-party video content rating unit. The third party video content rating unit is configured to be rendered on top of the media player.

### APPLICATIONS FOR CLAIM OF PRIORITY

This Application claims the benefit under 35 U.S.C. §119(e) of U.S. Provisional Application Ser. No. 60/946,074 filed Jun. 25, 2007, entitled “Third-Party Aggregated Video Rating System.” This Application is also related to commonly-owned U.S. patent application Ser. No. 9/665,482, filed Sep. 20, 2000, entitled “Method and Apparatus for Delivery of Targeted Advertising and Content Based on User Interaction with Online Queries on a Wide Area Network.” The entireties of the disclosures of the above-identified applications are incorporated herein by reference as though set forth in full.

### BACKGROUND INFORMATION

1. Field

The embodiments described herein relate to Internet advertising, and more particularly to providing a third-party ad sponsored video rating system that allows the users of video hosting provider(s) to rate their video content.

2. Background

There are currently numerous sites and video hosting providers (i.e., video content websites) on the Internet serving and hosting premium and/or user generated videos such as YOUTUBE™, METACAFE™, GOOGLE VIDEO™, BRIGHTCOVE™, MYSPACE™, ROO NETWORKS™, etc. The most common method for these properties or vendors to monetize the video views, or impressions, is to serve banner ads on the page adjacent to the video or video player. Most of these banner ads are not able to target based on the content of the video, due to the nature of professional and/or user generated content that can cover countless subject or content matter, e.g., wedding videos, stunts, testimonials, personal experiences, independent entertainment movies or shots, etc.

Conventional advertising or monetization methods for these providers include: pre-roll video ads, video commercials that stream before the user-generated and premium content. These methods and other developments to overlay advertisements next to or on top of the video to draw user's attention have also been in use. These methods tend to annoy users and deter them from viewing the requested video they have chosen to view, unless they know exactly what they want to watch and are willing to wait and view the advertisement—with no interaction.

Many major advertisers like to use video advertisement clips to advertise their clients' products and/or services on video content sites. However, it is important to distinguish the difference between premium video content and user generated video content. Premium video content is generally copyrighted content created by a commercial entity. Most premium content is used in traditional media via broadcast television, cable, and/or satellite networks, which monetize the premium content with commercial advertisements. The Internet equivalent of the commercial advertisement is the pre-roll video. Pre-roll videos require the user to view them before the user is actually shown the premium content.

These pre-roll videos are much less effective for user generated content. Unlike with longer premium content, user generated content is generally shorter and harder to classify. Forcing users to watch a 15 second pre-rolled video ad so that they can watch a short 20 second video clip is unreasonable. These user generated videos are usually promoted by viral methods (e.g. e-mails, instant messages, homepage links, etc.) or just plain word-of-mouth. Forcing a pre-roll video for user generated content will greatly diminish the viral and/or word-of-mouth appeal of a clip. But one thing users expect on a user generated content site is a rating system. Most video sites current allow users to rate or send videos to a friend. This allows the site's community to filter out good videos from bad. It's a feature that's heavily used and very natural for any user-generated content. However, what's been lacking thus far is a system that can effectively monetize the video rating feature.

### SUMMARY

Systems and methods for implementing a third-party aggregated video rating system are disclosed.

In one aspect, a computer implemented method for providing a third-party video content rating unit to a client device, is disclosed. A web browser running on the client device requests video content from an affiliate video content server. The media player running on the client device receives a data stream of the video content from the affiliate video content server, renders the video content and sends a request for the third-party video content rating unit to a third-party ad content server once the video content has been completely rendered. The third-party ad content server receives the request for the third-party video content rating unit, sends the third-party video content rating unit to the client device and streams advertising content to the third-party video content rating unit. The third party video content rating unit is configured to be rendered on top of the media player.

In another aspect, a system for providing third-party aggregated video content ratings is disclosed. The system includes an affiliate video content server, a client device and a third-party ad server. The affiliate video content device can be configured to store a plurality of video content files and generate a data stream to transmit a requested video content file. The client device can have both a web browser and a media player. The web browser is communicatively connected to the affiliate video content server and can be configured to allow a user to send a request for a video content file to the affiliate video content server. The media player is communicatively connected to the affiliate video content server and can be configured to receive and render the data stream of the requested video content file. The media player can also be further configured to generate a request for a third-party video content rating unit after the requested video content file has been completely rendered.

The third-party ad server is communicatively connected to the client device and can be configured to receive the request for the third-party video content rating unit, send the requested third-party video content rating unit to the client device (wherein, the third-party video content rating unit is configured to be overlaid on top of the media player) and stream advertising content to the third-party video content rating unit.

These and other features, aspects, and embodiments of the invention are described below in the section entitled “Detailed Description.”

### BRIEF DESCRIPTION OF THE DRAWINGS

Features, aspects, and embodiments of the inventions are described in conjunction with the attached drawings, in which:

FIG. 1, is a block diagram illustrating a wide area network (WAN) for delivering third-party generated video content rating units to a client device utilized by one or more users to view video content stored by a video hosting provider (i.e., web content server), in accordance with one embodiment;

FIG. 2 is a flow chart illustrating a method for providing a third-party video content rating unit to a client device, in accordance with one embodiment;

FIG. 3 is a screenshot illustrating video content being played on a media player, in accordance with one embodiment;

FIG. 4 is a screenshot illustrating a video content ratings unit in the process of being overlaid onto a media player, in accordance with one embodiment;

FIG. 5 is a screenshot illustrating a video content ratings unit that includes a multitude of frames that can be used to present various types of content, in accordance with one embodiment;

FIG. 6 is a screenshot illustrating a video content ratings unit playing an advertising video clip in one of the frames, in accordance with one embodiment;

FIG. 7 is a screenshot illustrating one of the frames of a video content ratings unit showing a clocked countdown to when tabulated video content ratings results will be available, in accordance with one embodiment; and

FIG. 8 is a screenshot illustrating a video content ratings unit displaying the overall user ratings results for a video clip, in accordance with one embodiment.

### DETAILED DESCRIPTION

Embodiments herein are described and directed for systems and methods for implementing a third-party aggregated video rating system. It will be obvious, however, that the embodiments may be practiced without some or all of these specific details. In other instances, well known process operations have not been described in detail in order not to unnecessarily obscure the present invention.

As used herein, the Internet or World Wide Web (WWW) uses a hypermedia (i.e., comprising of graphics, audio, video, plain text, hyperlinks, etc.) based system for enabling the browsing of Internet sites. As its name implies, the WWW (i.e., Internet) is comprised of many websites linked together allowing users to travel from one website to another simply by clicking on hyperlinks. To access the web, a user (i.e., client) typically runs a web browser program (e.g., FIREFOX™, NETSCAPE™, INTERNET EXPLORER™, SAFARI™, OPERA™, CAMINO™, etc.) that assists the user in navigating from among the various websites on the WWW and renders the web pages associated with those websites for viewing by the user.

Webpages are typically written in HyperText Markup Language (HTML), Dynamic HyperText Markup Language (DHTML) or Extensible HyperText Markup Language (XHTML). DHTML denotes a collection of technologies used together to create interactive and animated web sites by using a combination of a static markup language (i.e., HTML), a client-side scripting language (such as JAVASCRIPT™), a presentation definition language (i.e., CSS), and a Document Object Model. DHTML based webpages use client-side scripting to change the variables of the presentation definition language (i.e., HTML) to affect the look and function of otherwise “static” HTML page content, after the page has been fully loaded and during the rendering process.

The term Internet ad provider (i.e., ad server) can denote any Internet advertisement provider that store Internet advertisements used in online marketing and delivers them to website visitors/users. Ad servers come in two general categories: local ad servers and third-party (or remote) ad servers. Local ad servers are typically run by a single publisher (i.e., web content provider) and serve ads to that publisher's own domains, allowing fine-grained creative, formatting, and content control by that publisher. Third-party ad servers can serve ads across domains owned by multiple publishers (web content providers). They can deliver the ads from one central source (third-party ad server) so that advertisers and publishers can track the distribution of their online advertisements, and have one location for controlling the rotation and distribution of their advertisements across the web.

Internet advertisements can take any form as along as it can be rendered onto a web browser, a software object or equivalent application. Examples include: static graphical banners, interactive polls, interactive games, animated ads, multimedia clips, streaming video, etc. Rich-media denotes interactive multimedia web content that includes audio, graphics, image, video and animation in addition to traditional media (text and graphics).

Video hosting providers (i.e., video content websites) are websites on the Internet that host and serve premium and/or user generated video content (e.g., clips, full length movies/episodes, etc.) for Internet users to stream and download. Examples of video hosting providers include, but are not limited to: YOUTUBE™, METACAFE™, GOOGLE VIDEO™, BRIGHTCOVE™, MYSPACE™, ROO NETWORKS™, etc. A video player is a type of media player for playing back digital video data from files of appropriate formats such as MPEG, AVI, REALVIDEO™, QUICKTIME™, etc. Examples of video players include, but are not limited to: WINDOWS MEDIA PLAYER™, QUICKTIME™, VLD MEDIAPLAYER™, REAL PLAYER™, ZOOM PLAYER™, etc. A user will typically need to load a video player onto his/her client device (e.g., personal computer, thin-client terminal, mobile communications device, etc.) in order to view and enjoy the video content posted on video hosting provider websites.

As discussed above, there is a need for new and innovative methods and/or systems to monetize the Internet video rating feature. In view of the foregoing, it should appreciated that there are a number of inherent advantages offered by a third-party aggregated video content rating system that can be used across multiple video content sites and video player platforms to serve a sponsored rating system at the end of user generated videos, which will include a sponsor video and a creative ad placement. By pairing sponsored advertising content with a video content rating unit that is delivered to a user after he/she has finished viewing a video clip, the video rating feature can generate sponsored ad revenue (become monetized).

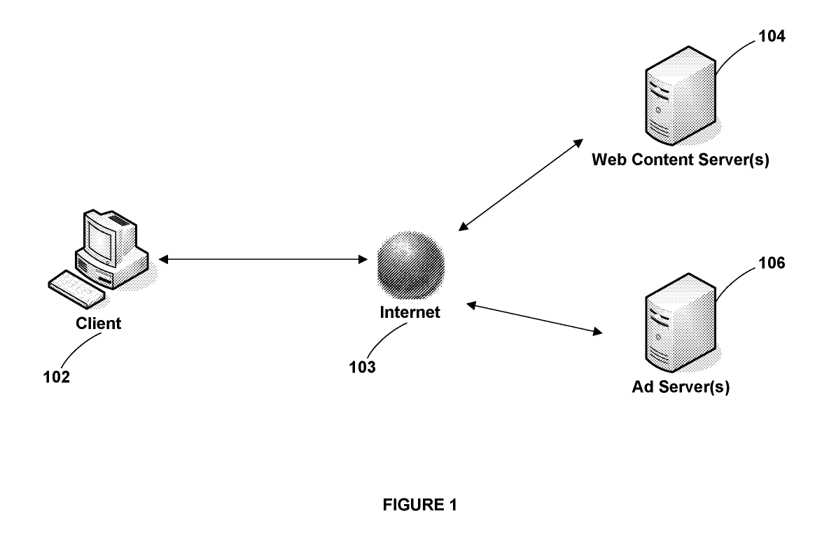

FIG. 1, is a block diagram illustrating a wide area network (WAN) for delivering third-party generated video content rating units to a client device utilized by one or more users to view video content stored by a video hosting provider (i.e., web content server), in accordance with one embodiment. As depicted, the system can include a client device 102 (hosting both a web browser and a video/media player) that is in communications by way of the Internet 103 with a web content server 104, and a third-party ad server 106. It should be appreciated that the client 102 can be in communications with multiple servers of each server type (e.g., web content server 104, third-party ad server 106, etc.) and that single servers were used in this depiction for the sake of simplicity and is not intended to limit the scenario to single servers of each server type. The client device 102 can be a personal computer (such as a desktop or laptop computer), thin-client terminal (such as a dumb terminal networked to a server or mainframe) or a mobile communications device (such as a mobile phone).

During an Internet 103 web surfing session, the client 102 can make a request for a web page from the web content server 104, which is configured to send the requested page back to the client 103 in the form of a Hypertext Markup Language (HTML) or equivalent file type (e.g., Extensible Markup Language (XML), Extensible Hypertext Markup Language (XHTML), and Extensible Bindings Language (XBL)). In addition to the base markup language and text, the web page can include various types of embedded content such as audio objects/files, video objects/files and/or pictures. Once received by the client device 102, the requested web page can be rendered and viewed by a user on the web browser application that runs on the client device 102. When the web page includes embedded content, such as a video object/file, an appropriate media player (i.e. video player) can be launched to open and play (i.e., render) the video object/file. In one embodiment, the video object/file is associated with video content that is stored on the web content server 104. When opened or activated, the video object/file is configured to initiate a data communications channel (i.e., data stream) between the media player and the web content server 104 hosting the video content that is associated with the video object/file, thus allowing a “video stream” of the video content to be displayed on the media player to the user. In another embodiment, the video object/file is configured as a complete video content data file. That is, the video object/file is a complete media file that can be played in its entirety by the media player without the need for a data stream from a web content server 104.

In one embodiment, the video object/file includes an embedded command (script) that instructs the media player to generate and send a request for a video content rating unit to a third-party ad server 106 when the video content is finished playing. That is, the media player is instructed by the video object/file to generate and send a request for a video content rating unit to the third-party ad server 106 when the user(s) are finished viewing the video object/file (e.g., user generated video, premium video content, etc.). In another embodiment, the media player is configured to automatically generate and send a request for a video content rating unit to the third-party ad server 106 when it determines that the video content data stream has ceased or that the data stream channel is disconnected. Once the third-party ad server 106 receives the request, it is configured to send a video content rating unit (i.e., third-party video content rating unit) to the client device 102 hosting the media player.

The video content rating unit can appear as an overlay over the media player and can include one or more frames that can be used to present various types of static or interactive content to a user. For example, in certain embodiments, the video content rating unit can include a first frame which presents a video content rating classification module (using symbols, numbers, or other metrics) for users to rate the video content if they choose, while at the same time a video advertisement clip is streamed to a second frame as users pick their rating (with the sponsor of the video advertisement clip being presented as an ad banner in a third frame). In one embodiment, the video advertisement clip that is streamed by the third-party ad server 106 to the video content rating unit is chosen based on the subject matter of the video content. In another embodiment, the video advertisement clip that this streamed by the third-party ad server 106 to the video content rating unit is chosen based on the target audience for the video content. It should be appreciated, however, that the third-party ad server 106 can be configured to choose the video advertisement clip based on any video content attribute that allows a sponsor to selectively provide the most relevant video advertising to a user.

Once submitted by a user, the response (i.e., video content rating) can be sent back to the third-party ad server 106, which then can post the user response and user information (IP address, date, time, site) to a user information database that can be communicatively connected to the ad content server 106, and send back overall user rating results (accumulated from the other users of the same website) for the video content just viewed by the user along with other related links or viral methods (e.g., instant messaging, e-mails, etc.) to share the video content with other users. Additionally, the third-party ad server 106 can send a cookie to the user's web browser so that a user profile can be generated for that user to track the user response and user information.

In one embodiment, if the same video content (i.e., video clip A) is being streamed or played across multiple affiliate web content sites (or web content servers 104) and/or media players that use the same third-party video content rating unit, the rating totals can be aggregated across all the affiliated web content sites and media players that host or play the video content (i.e., video clip A). That is, the third-party video content rating unit can be used to aggregate user ratings for video clip A across the multiple affiliate websites hosting the video clip A and/or media players (that use the same third-party video content rating unit) that have been used to play video clip A. Providing a third-party rating system that can aggregate ratings across multiple sites and players is unique and provides value to content developers to increase interest and viewership, while adding value to web content sites and media players by increasing views and sharing the ratings and views of users across the Internet, as compared to a single source.

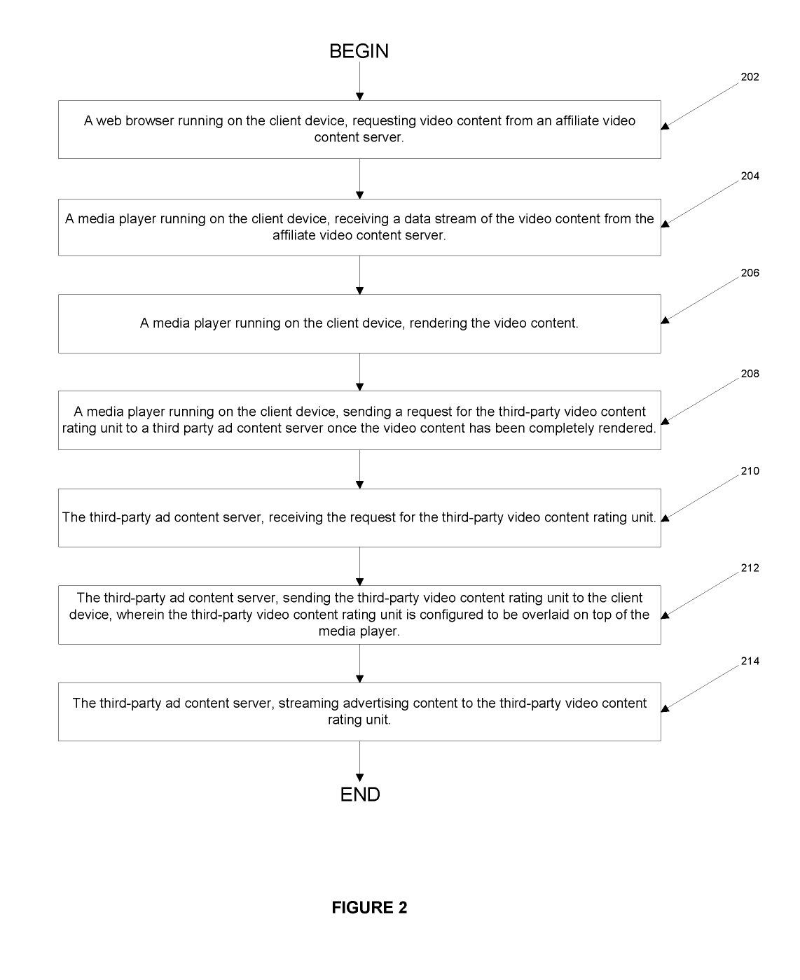

FIG. 2 is a flow chart illustrating a method for providing a third-party video content rating unit to a client device, in accordance with one embodiment. In step 202, the web browser running on the client device can send a request for video content from an affiliate video content server. As used herein, an affiliate video content server can denote any video hosting provider (i.e., video content website) that uses a common video content rating unit from the same third-party provider. Examples of video content providers include, but are not limited to: YOUTUBE™, METACAFE™, GOOGLE VIDEO™, BRIGHTCOVE™, MYSPACE™, ROO NETWORKS™, etc. In step 204, the media player running on the client device can receive a data stream of the video content from the affiliate video content server. In one embodiment, the data stream of video content from the affiliate video content server begins when the media player opens a video content object/file that is embedded within the web page that is sent to the client device by the affiliate video content server once it receives the request for video content from the client device. In step 206, once the media player starts receiving the data stream of the video content, it can begin to render (play) the video for users to view.

Moving on to step 208, once the video content has been completely rendered (finished playing), the media player is configured to send a request for the third-party video content rating unit to the third-party ad server. It should be appreciated, however, that there can be other triggers for the media player to generate and send the third-party video content rating unit request. In an alternative embodiment, the media player can be configured to automatically generate and send a request for a video content rating unit to the third-party ad server when it determines that the video content data stream has ceased or that the data stream channel is disconnected.

In steps 210 through 214 once the third-party ad server 106 receives the request, it is configured to send a video content rating unit (i.e., third-party video content rating unit) to the client device hosting the media player. The video content rating unit can be overlaid on top of the media player and can include one or more frames that can be used to present various types of static and/or interactive content to a user. For example, in certain embodiments, the video content rating unit can include a first frame which presents a video content rating classification module (using symbols, numbers, or other metrics) for users to rate the video content if they choose, while at the same time a video advertisement clip is streamed to a second frame as users pick their rating (with the sponsor of the video advertisement clip being presented as an ad banner in a third frame). In one embodiment, the video advertisement clip that is streamed by the third-party ad server to the video content rating unit is chosen based on the subject matter of the video content. In another embodiment, the video advertisement clip that this streamed by the third-party ad server to the video content rating unit is chosen based on the target audience for the video content. It should be appreciated, however, that the third-party ad server can be configured to choose the video advertisement clip based on any video content attribute that allows a sponsor to selectively provide the most relevant video advertising to a user.

As discussed above, once submitted by a user, the response (i.e., video content rating) can be sent back to the third-party ad server, which then can post the user response and user information (IP address, date, time, site) to a user information database that can be communicatively connected to the third-party ad content server, and send back overall user rating results (accumulated from the other users of the same website) for the video content just viewed by the user along with other related links or viral methods (e.g., instant messaging, e-mails, etc.) to share the video content with other users. Additionally, the third-party ad server can send a cookie to the user's web browser so that a user profile can be generated for the user to track the user response and user information.

In one embodiment, if the same video content (i.e., video clip A) is being streamed or played across multiple affiliate web content sites (or web content servers) and/or media players that use the same third-party video content rating unit, the rating totals can be aggregated across all the affiliated web content sites and media players that host or play the video content (i.e., video clip A). That is, the third-party video content rating unit can be used to aggregate user ratings for video clip A across the multiple affiliate websites hosting the video clip A and/or media players (that use the same third-party video content rating unit) that have been used to play video clip A. Providing a third-party rating system that can aggregate ratings across multiple sites and players is unique and provides value to content developers to increase interest and viewership, while adding value to web content sites and media players by increasing views and sharing the ratings and views of users across the Internet, as compared to a single source.

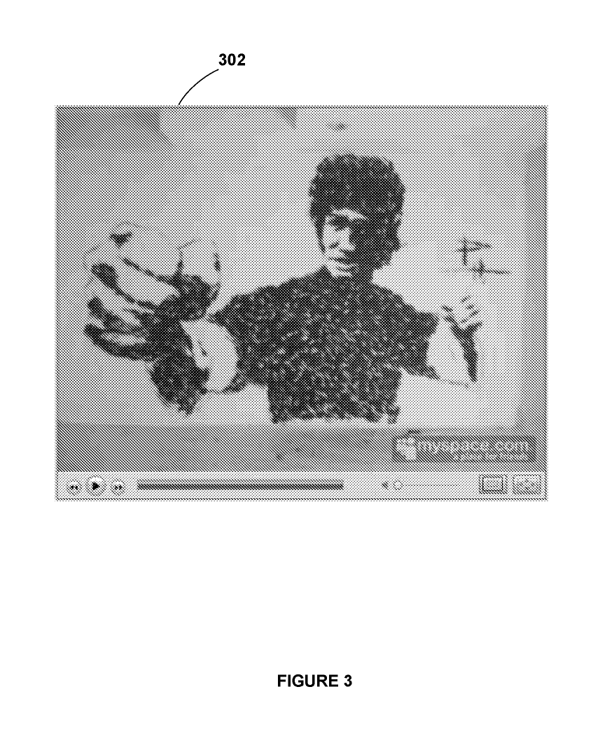

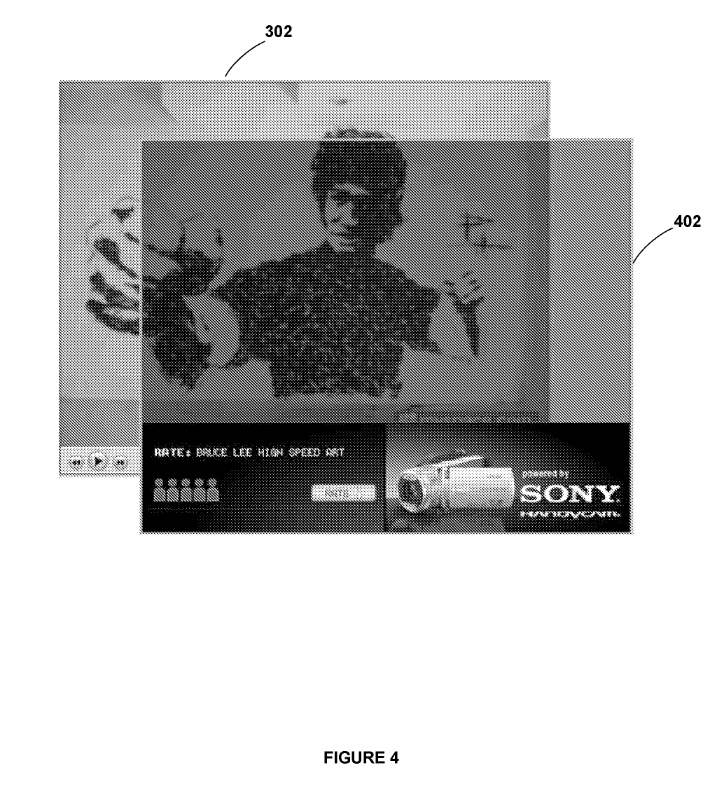

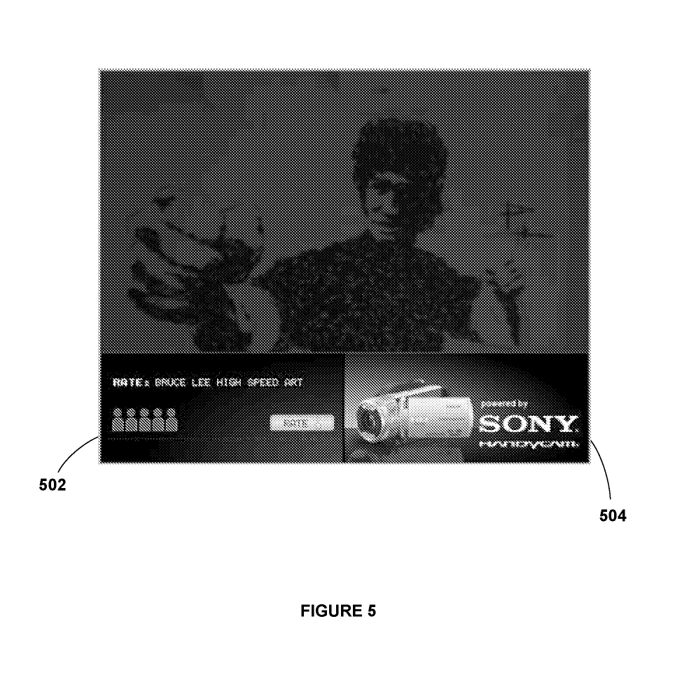

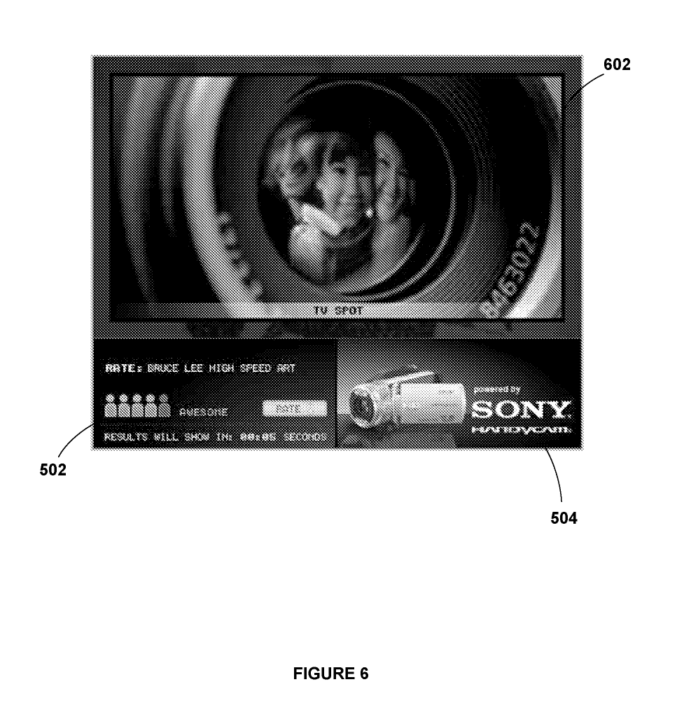

FIGS. 3-8 are screenshots that illustrate how the third-party video content rating unit works in conjunction with the media player. As depicted in the screenshots, a video content rating unit 402 can be overlaid on top of the media player 302 (or video player) once a video clip has finished playing (finished being rendered). The video content rating unit 402 can include one or more frames. For example, as depicted in FIG. 6, the video content rating unit 402 can include three frames. The first frame 502 can include a video content rating classification module (using symbols, numbers, or other metrics) that allows users to rate the video content they've just viewed. The second frame 602 can include a streaming video advertisement clip that plays while the users pick their rating using the video content rating classification module. A third frame 504 can include a banner ad with the name (or other identification marks) of the sponsor of the video advertisement clip.

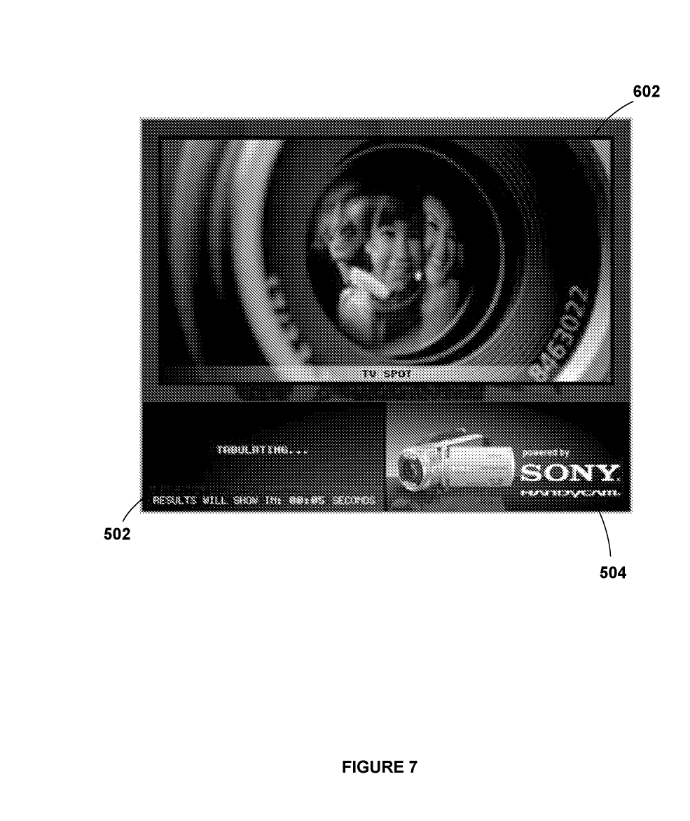

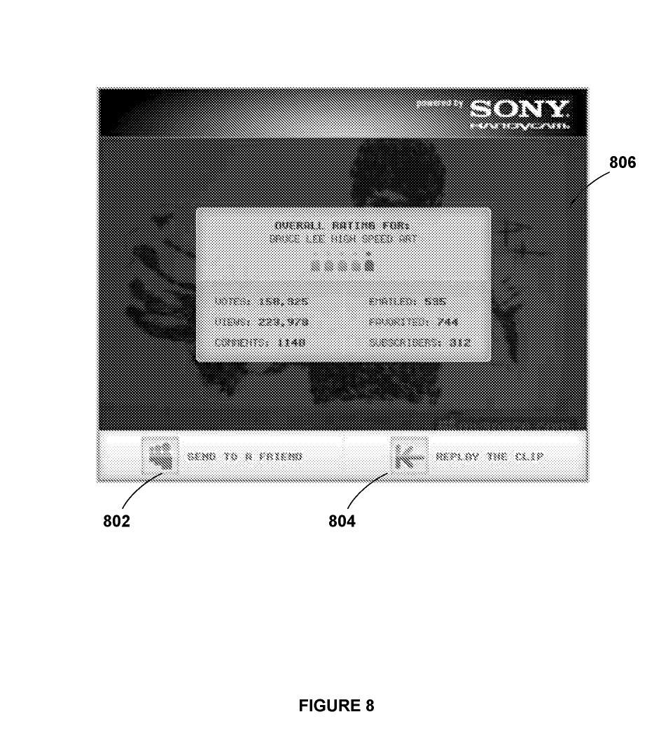

As shown in FIGS. 7 and 8, the frames can dynamically switch between various types of content. For example, once submitted by a user, the frame can switch from a video content rating classification module to a dynamic clock countdown graphic (telling the user that that the ratings results are being tabulated). The response (i.e., video content rating) can be sent to the third-party ad server, which then can post the user response and user information (IP address, date, time, site) to a user information database that is communicatively connected to the third-party ad content server, and send back overall user rating results 806 (accumulated from the other users of the same or other websites) for the video content just viewed by the user along with the option to replay the video content 804, other related links and/or viral methods 802 (e.g., instant messaging, e-mails, etc.) to share the video content with other users. Additionally, the third-party ad server can send a cookie to the user's web browser so that a user profile can be generated for the user to track the user response and user information.

Any of the operations that form part of the embodiments described herein are useful machine operations. The invention also relates to a device or an apparatus for performing these operations. The systems and methods described herein can be specially constructed for the required purposes, such as the specialty servers (e.g., ad server, web content servers, etc.) discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

Certain embodiments can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

While certain embodiments of the inventions have been described above, it will be understood that the embodiments described are by way of example only. Accordingly, the inventions should not be limited based on the described embodiments. Rather, the scope of the inventions described herein should only be limited in light of the claims that follow when taken in conjunction with the above description and accompanying drawings.

What is claimed is:

1. A computer implemented method for providing a third-party video content rating unit to a client device, comprising:
a web browser running on the client device,
requesting video content from an affiliate video content server;
a media player running on the client device,
receiving a data stream of the video content from the affiliate video content server,
rendering the video content, and
sending a request for the third-party video content rating unit to a third-party ad content server once the video content has been completely rendered; and
the third-party ad content server,
receiving the request for the third-party video content rating unit,
sending the third-party video content rating unit to the client device, wherein the third-party video content rating unit is configured to be overlaid on top of the media player, and
streaming advertising content to the third-party video content rating unit.

2. The computer implemented method for providing a third-party video content rating unit to a client device, as recited in claim 1, further including:
the third party video content rating unit,
receiving a video content rating submission from a viewer of the rendered video content,
sending the video content rating to the third-party ad content server,
receiving aggregated video content rating results, and
displaying the aggregated video content rating results to the viewer.

3. The computer implemented method for providing a third-party video content rating unit to a client device, as recited in claim 2, wherein the third-party ad content server is configured to receive video content rating submissions from one or more other viewers of the video content using other instantiations of the third-party video content unit.

4. The computer implemented method for providing a third-party video content rating unit to a client device, as recited in claim 2, wherein the aggregated video content rating results include video content ratings submitted by one or more other viewers of the video content.

5. The computer implemented method for providing a third-party video content rating unit to a client device, as recited in claim 1, choosing the advertising content to stream to the third-party video content unit based on an attribute of the video content.

6. The computer implemented method for providing a third-party video content rating unit to a client device, as recited in claim 5, wherein the attribute relates to the subject matter of the video content.

7. The computer implemented method for providing a third-party video content rating unit to a client device, as recited in claim 5, wherein the attribute relates to the target audience for the video content.

8. The computer implemented method for providing a third-party video content rating unit to a client device, as recited in claim 1, wherein the third-party video content rating unit includes a first frame and a second frame.

9. The computer implemented method for providing a third-party video content rating unit to a client device, as recited in claim 1, wherein the first frame includes a video content rating module and the second frame is configured to render the streamed advertising content.

10. The computer implemented method for providing a third-party video content rating unit to a client device, as recited in claim 9, wherein the third-party video content rating unit includes a third frame that includes an advertisement banner.

11. The computer implemented method for providing a third-party video content rating unit to a client device, as recited in claim 1, wherein the client is a personal computer.

12. The computer implemented method for providing a third-party video content rating unit to a client device, as recited in claim 1, wherein the client is a mobile communication device.

13. The computer implemented method for providing a third-party video content rating unit to a client device, as recited in claim 1, further including:
building a user profile based on the video content rating submitted by the viewer; and
embedding a cookie on the viewer's web browser to identify the viewer with the user profile.

14. A system for providing third-party aggregated video content ratings, comprising:
an affiliate video content server configured to store a plurality of video content files and generate a data stream to transmit a requested video content file;
a client device having a web browser and a media player,
the web browser communicatively connected to the affiliate video content server and configured to allow a user to send a request for a video content file to the affiliate video content server, and
the media player communicatively connected to the affiliate video content server and configured to receive and render the data stream of the requested video content file, the media player further configured to generate a request for a third-party video content rating unit after the requested video content file has been rendered; and
a third-party ad server communicatively connected to the client device and configured to,
receive the request for the third-party video content rating unit,
send the requested third-party video content rating unit to the client device, wherein the third-party video content rating unit is configured to be overlaid on top of the media player, and
stream advertising content to the third-party video content rating unit.

15. The system for providing third-party aggregated video content ratings, as recited in claim 14, further including:
the third party video content rating unit,
receiving a video content rating submission from the user,
sending the video content rating to the third-party ad content server,
receiving aggregated video content rating results, and
displaying the aggregated video content rating results to the user.

16. The system for providing third-party aggregated video content ratings, as recited in claim 15, wherein the third-party ad content server is configured to receive video content rating submissions from one or more other viewers of the video content using other instantiations of the third-party video content unit.

17. The system for providing third-party aggregated video content ratings, as recited in claim 15, wherein the aggregated video content rating results include video content ratings submitted by one or more other viewers of the video content.

18. The system for providing third-party aggregated video content ratings, as recited in claim 14, choosing the advertising content to stream to the third-party video content unit based on an attribute of the video content.

19. The system for providing third-party aggregated video content ratings, as recited in claim 18, wherein the attribute relates to the subject matter of the video content file.

20. The system for providing third-party aggregated video content ratings, as recited in claim 14, wherein the attribute relates to the target audience for the video content file.

21. The system for providing third-party aggregated video content ratings, as recited in claim 14, wherein the third-party video content rating unit includes a first frame and a second frame.

22. The system for providing third-party aggregated video content ratings, as recited in claim 14, wherein the first frame includes a video content rating module and the second frame is configured to render the streamed advertising content.

23. The system for providing third-party aggregated video content ratings, as recited in claim 22, wherein the third-party video content rating unit includes a third frame that includes an advertisement banner.

24. The system for providing third-party aggregated video content ratings, as recited in claim 14, wherein the client is a personal computer.

25. The system for providing third-party aggregated video content ratings, as recited in claim 14, wherein the client is a mobile communication device.

26. The system for providing third-party aggregated video content ratings, as recited in claim 14, further including:
building a user profile based on the video content rating submitted by the user; and
embedding a cookie on the user's web browser to identify the user with the user profile.
